(19) United States
(12) Patent Application Publication
(10) Pub. No.: US 2012/0072843 A1
(43) Pub. Date: Mar. 22, 2012

(54) Figment collaboration system

(75) Inventors: David Durham, Northridge, CA (US); Amber Samdahl, Altadena, CA (US); Joshua B. Gorin, Glendale, CA (US)

(73) Assignee: DISNEY ENTERPRISES, INC., BURBANK, CA (US)

(21) Appl. No.: 12/924,129

(22) Filed: Sep. 20, 2010

(51) Int. Cl. G06F 3/048

(52) U.S. Cl. 715/733

(57) ABSTRACT

There is provided a system and method for the Figment collaboration system, providing intuitive user interfaces for collaboration. There is provided a system comprising an input surface, a display outputting on the input surface, and a server having a processor configured to receive a first input from the input surface, convert the first input into a first content box, generate contextual content suggestions based on the first content box, and show the first content box and the contextual content suggestions in a workspace canvas output to the display. By utilizing data sources accessible through a network, the contextual content suggestions may provide highly relevant data and remote user access to facilitate enhanced collaboration. At the same time, by supporting familiar workflows similar to working with conventional whiteboards, users can readily use the Figment collaboration system without the stress of having to learn poorly designed and complicated collaboration interfaces.

### BACKGROUND OF THE INVENTION

1. Field of the Invention

The present invention relates generally to user interfaces. More particularly, the present invention relates to intuitive user interfaces for collaboration.

2. Background Art

Collaboration systems presently in use are often found wanting in many respects. Traditional collaboration systems such as whiteboards, while low cost and easy to setup, limit collaboration to a single physical location and do not leverage the rich resources of online data available to enhance collaboration sessions. Multinational companies and other large groups of international users such as software development teams may require technologically advanced collaboration tools with flexible time shifting, language translation and regional customization, networked data access, and other features. Thus, traditional collaboration solutions may be inappropriate for larger collaborative efforts.

Unfortunately, more technologically advanced collaboration tools are often difficult for users to understand and operate. For example, many of these tools rely on conventional video projector technology to provide a common viewing screen, distracting both the presenter and the audience with shadows and stray projections. Additionally, such tools are often difficult to use for content creation and presentation, utilizing unintuitive user interfaces with cluttered navigation, drab aesthetics, high learning curves, and rigid methods of collaboration. As such, less technically inclined users and users with a lower tolerance for poor interface design may be unwilling or unable to provide meaningful collaborative participation. The loss of input and feedback from these alienated users may severely hamper collaborative efforts and unduly restrict the flow of ideas from all participants.

Accordingly, there is a need to overcome the drawbacks and deficiencies in the art by providing an intuitive and easy to use collaboration system encouraging optimal flow of ideas within a diverse international participant base of varied skill levels.

### SUMMARY OF THE INVENTION

There are provided systems and methods for the Figment collaboration system, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for implementing the Figment collaboration system, according to one embodiment of the present invention;

FIG. 2 presents a diagram of a user interface presented by the Figment collaboration system, according to one embodiment of the present invention; and

FIG. 3 shows a flowchart describing the steps, according to one embodiment of the present invention, by which the Figment collaboration system may be provided.

### DETAILED DESCRIPTION OF THE INVENTION

The present application is directed to a system and method for the Figment collaboration system. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

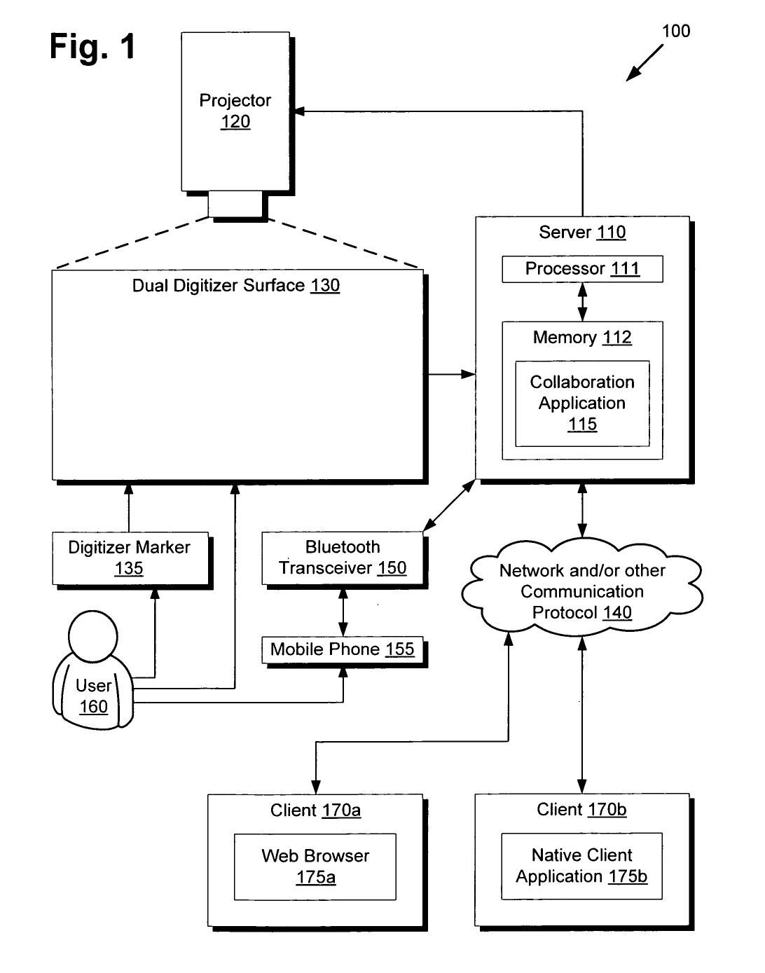

FIG. 1 presents a diagram of a system for implementing the Figment collaboration system, according to one embodiment of the present invention. Diagram 100 of FIG. 1 includes server 110, projector 120, dual digitizer surface 130, digitizer marker 135, network and/or other communication protocol 140, Bluetooth transceiver 150, mobile phone 155, user 160, and clients 170a and 170b. Server 110 includes processor 111 and memory 112. Memory 112 includes collaboration application 115. Client 170a includes web browser 175a. Client 170b includes native client application 175b.

The configuration shown in diagram 100 illustrates the use of the Figment collaboration system on a single shared surface, or dual digitizer surface 130, supporting a primary presenter or moderator, user 160, and two participating audience users, or the users of client 170a and 170b. For example, client 170a may comprise a laptop computer executing web browser 175a to access a web interface provided by collaboration application 115, which executes on processor 111 within memory 112 of server 110. Client 170b may comprise a mobile phone with a custom programmed native client application 175b, which also interfaces with collaboration application 115. Thus, as shown in diagram 100, collaboration application 115 can provide support for various clients running specific platforms by providing custom client side applications. Alternatively, a unified application may be written using a commonly accessible platform such as HTML5. Network and/or other communication protocol 140 may comprise a local area network, such as a Wi-Fi intranet. However, in alternative embodiments, client 170a and 170b may be remotely located and network and/or other communication protocol 140 may comprise a public wide area network such as the Internet. In yet other embodiments, network and/or other communication protocol 140 may use alternative non-network based protocols for communication.

Dual digitizer surface 130, as the name suggests, may provide both an active digitizer and a single or multi-touch sensitive surface, such as a capacitive touchscreen. Since the user is not literally drawing directly onto dual digitizer surface 130 using traditional ink markers, projector 120 is utilized to project the actual interface display onto dual digitizer surface 130. Collaboration application 115 may be configured to display a workspace canvas on projector 120 at a high frame-rate, such as 60 frames per second, while continuously reading drawing inputs received from user 160 using digitizer marker 135 on dual digitizer surface 130 to update the workspace canvas displayed by projector 120 with new drawing data, thereby providing the appearance of real-time drawing.

Projector 120 may comprise a short throw or ultra-short throw video projector mounted overhead in relation to dual digitizer surface 130 to minimize distracting shadows and stray projections. In alternative embodiments, dual digitizer surface 130 may include an embedded display, such as an LCD display panel, to substitute for projector 120. However, for large screens spanning several feet, projector technology may still provide the most cost effective display method for large screen collaboration interfaces.

User 160 may use both digitizer marker 135 and touch gestures to directly manipulate dual digitizer surface 130. For example, digitizer marker 135 may be used to draw text, shapes, and graphics on dual digitizer surface 130, whereas touch gestures may manipulate the user interface to move items, make selections, zoom and highlight, and perform other tasks. However, depending on user preference, touch gestures may also be extended for use in drawing tasks as well. Alternative methods of input, such as voice recognition or hand and body movement detectors, may also be supported as well. Furthermore, while only a single digitizer marker 135 is shown, multiple digitizer markers might be utilized, for example to support markers with different colors or functions.

As user 160 approaches dual digitizer surface 130 which may be mounted on a wall, Bluetooth transceiver 150 may communicate with mobile phone 155 held by user 160 to uniquely identify user 160. Alternative methods of user identification may also be used, such as biometric scanning, RFID tags, or detection of devices having identification data. For example, in an RFID embodiment, an employee identification card with an embedded RFID tag may substitute for mobile phone 155 and an RFID reader may substitute for Bluetooth transmitter 150. To identify other users participating in the collaboration, such as the users of client 170a and 170b, any combination of identifiers may be used, such as client IP address, client MAC address, username and password, or employee identifier card with embedded barcode or RFID tag. In this manner, user specific interface customizations, past project and history data, and other associated user data can be automatically loaded and shown on a user interface displayed on dual digitizer surface 130 through collaboration application 115 outputting through projector 120. Multiple concurrent moderator users may also be detected for supporting joint and team presentations.

Thus, when user 160 interacts with dual digitizer surface 130, the experience is similar to using a traditional whiteboard. However, since the drawing input from user 160 is read from dual digitizer surface 130, it may be further processed by collaboration application 115, for example by applying optical character recognition (OCR) to convert handwriting to text. If mistakes are made during recognition, the user may select the correct conversion using, for example, a drop down menu. Recognition accuracy may be improved by utilizing past conversion history, limiting recognized vocabulary to specific relevant topics or fields, or by using other measures. The text may then be contextually analyzed using any profile and history data available for user 160 to, for example, provide relevant data access and communicate with project collaborators through video or audio teleconferencing, instant messaging chat, social networking, or other methods of communication.

Dual digitizer surface 130 may provide a unified workspace that is synchronized with views shown by client 170a and 170b, allowing all users to see the same shared workspace. Additional remote dual digitizer surfaces may be synchronized and peered with dual digitizer surface 130, allowing concurrent collaboration with several conference rooms in different regions. If the regions are located in countries with different primary languages, then an automatic language translation filter may be applied to convert received text to the local language before displaying and to convert text to a target foreign language before sending to other dual digitizer surfaces.

Alternatively or additionally, client 170a and 170b may each show an independent local view that is connected to the view shown on dual digitizer surface 130. For example, a user of client 170a may create a text box in a private local view, and then share the text box by quickly dragging or “flicking” the text box into the main workspace canvas view shown on dual digitizer surface 130. Furthermore, the main workspace may possess its own e-mail address, telephone number, or social networking account to facilitate collaboration from a wide variety of users and contribution tools. Thus, for example, a user might send an attachment of an image to an e-mail address corresponding to the collaboration session, and the image may appear within a content box on dual digitizer surface 130 once the e-mail is received. Once such a contribution is received, the moderator, or user 160, may then solicit feedback from other participating users and decide whether to integrate or discard the contribution from client 170a.

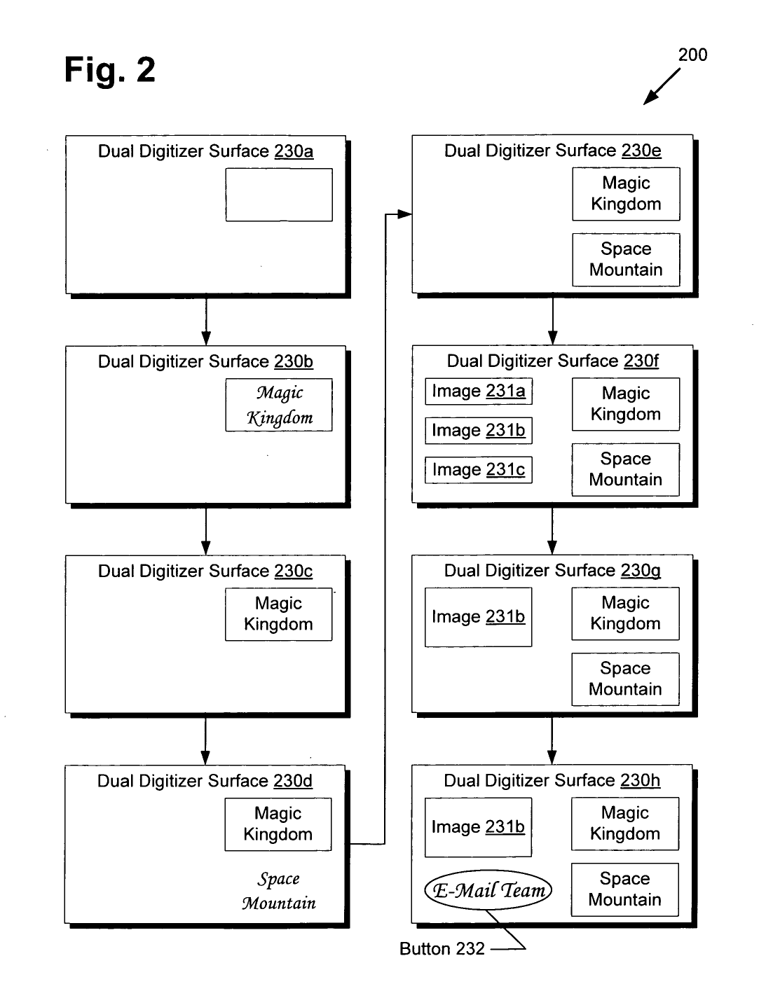

Moving to FIG. 2, FIG. 2 presents a diagram of a user interface presented by the Figment collaboration system, according to one embodiment of the present invention. Diagram 200 of FIG. 2 includes dual digitizer surfaces 230a through 230h. Dual digitizer surface 230f includes images 231 through 231c. Dual digitizer surface 230g includes image 231b. Dual digitizer surface 230h includes image 231b and button 232. With regards to FIG. 2, dual digitizer surfaces 230a through 230h may each correspond to dual digitizer surface 130 in FIG. 1. Dual digitizer surfaces 230a through 230h may each also correspond to interfaces shown by web browser 175a on client 170a and native client application 175b on client 170b in FIG. 1. As previously discussed, each client may include a private view and/or a shared view synchronized with the main dual digitizer surface 130.

Starting with dual digitizer surface 230a, the user may be presented with a clean, blank canvas, which may be “skinned” with any number of user selectable themes changeable on the fly to provide an attractive looking interface. Referring to FIG. 1, user 160 may simply draw a rough square or rectangle using digitizer marker 135 on dual digitizer surface 130. Collaboration application 115 may then recognize the rectangular shape drawn by the user to instantiate a note card or content box, which may then be filled with any kind of text, graphics, data, widgets, or other content, which may be drawn by user 160 or retrieved from other sources accessible from network and/or other communication protocol 140.

For example, moving to dual digitizer surface 230b, user 160 may handwrite the words “Magic Kingdom” within the instantiated content box. Moving to digitizer surface 230c, the handwritten words may be converted into a text string using a machine-readable text encoding such as ASCII or Unicode through optical character recognition, which may occur automatically or upon manual activation, for example by touching an icon for text conversion positioned in the corner of the content box. Similarly, a remove icon, such as an X mark or a trashcan graphic, may be positioned in the corner and touched for easy removal of content boxes. Alternatively or additionally, a trashcan icon may be placed in the interface outside of the content boxes, allowing content boxes to be dragged into the trashcan.

Instead of drawing a shape first and then adding text, user 160 may also reverse the previous sequence of steps by writing text first and draw an enclosing shape afterwards. Thus, as shown in dual digitizer surface 230d, the user may simply start writing a phrase, such as “Space Mountain”, in any empty space available on the canvas. After drawing an enclosing shape, such as a rectangle, around the newly written text, the handwritten text may be automatically converted into machine-readable text, as shown in dual digitizer surface 230e. Alternatively, the text may remain in handwritten form until manually converted, as previously discussed.

After some amount of ideas are provided by the user, the system may begin to suggest contextual content to help guide and further the idea brainstorming process. For example, as shown in dual digitizer surface 230f, a list of image thumbnails, shown as images 231a through 231c, may be shown in the user interface. However, other content may be provided besides images, such as text phrases, database entries, video clips, web links or other Internet content, widgets such as social networking applications, chat or conferencing windows with other users, and other types of content that may be deemed most contextually relevant and helpful by the collaboration system. Adaptive learning techniques may be utilized to optimize for the most contextually relevant selection of content, for example by analyzing history data from previous sessions, user profile data, and the present state of the workspace canvas.

For example, the collaboration system may observe that since a “Magic Kingdom” content box is present, the current collaboration session will likely focus on the Florida region. Other factors may be weighed to reinforce the Florida association, such as the close proximity of the “Magic Kingdom” and “Space Mountain” content boxes, a Florida employment location of the user, or previous collaboration sessions focusing on Florida. Thus, after the user provides the “Space Mountain” content box, images 231a through 231c may be shown as suggested contextual content, each relating to the “Space Mountain” attraction in the Florida area only. Additional available images may be browsed by, for example, using swipe gestures. The user may then select a particular image to remain on the workspace canvas, such as image 231b, as shown in dual digitizer surface 230g. Of course, if the Florida association is spurious, then the user may cancel the association and select the correct location, for example through a drop down menu showing other likely alternatives. Future collaboration sessions may also take corrections like this into account when formulating new suggestions, thereby progressively adapting to specific user thought processes.

The arrangement of the content boxes shown in dual digitizer surface 230g may be freely modified by the user, for example by touching and dragging to resize and move. Arrows or connectors may be drawn between content boxes to reinforce relationships visually. The system may automatically save the state of the workspace canvas during the entire session, allowing a particular collaboration session to be replayed or adjusted to a particular point in time, for example by dragging a slider in a time seek bar. In this manner, the complete thought process of a particular session can be observed, and the design from an earlier stage may be retrieved if desired.

Assuming that the present arrangement is already acceptable, user 160 may draw button 232, for example by handwriting “E-mail Team” and drawing an oval or circular shape around the handwriting. Thus, rectangular shapes may be used for content boxes, whereas circular or oval shapes may be used for command buttons. The user may then press button 232 to send a final version of the collaboration workspace canvas to all participating users, for example by exporting an image file and sending as an attachment by e-mail. Thus, in the case of the example shown in diagram 100 of FIG. 1, user 160 and the users of client 170a and 170b may each receive a finalized image at their respective e-mail addresses. A similar process may be used to support other functions, such as opening a video teleconferencing window with another user using the command “VTC [username]” or printing the workspace canvas to a local printer by using the command “Print”. Alternatively or additionally, a separate interface window, such as an auto-hide toolbar to the side, may be utilized to provide access to more advanced features. Of course, a user may also choose to ignore these facilities and simply work as if the system were providing a standard whiteboard. In this manner, users can comfortably and quickly utilize the Figment collaboration system as a standard whiteboard while learning more advanced features at their own preferred pace or by simply observing other users.

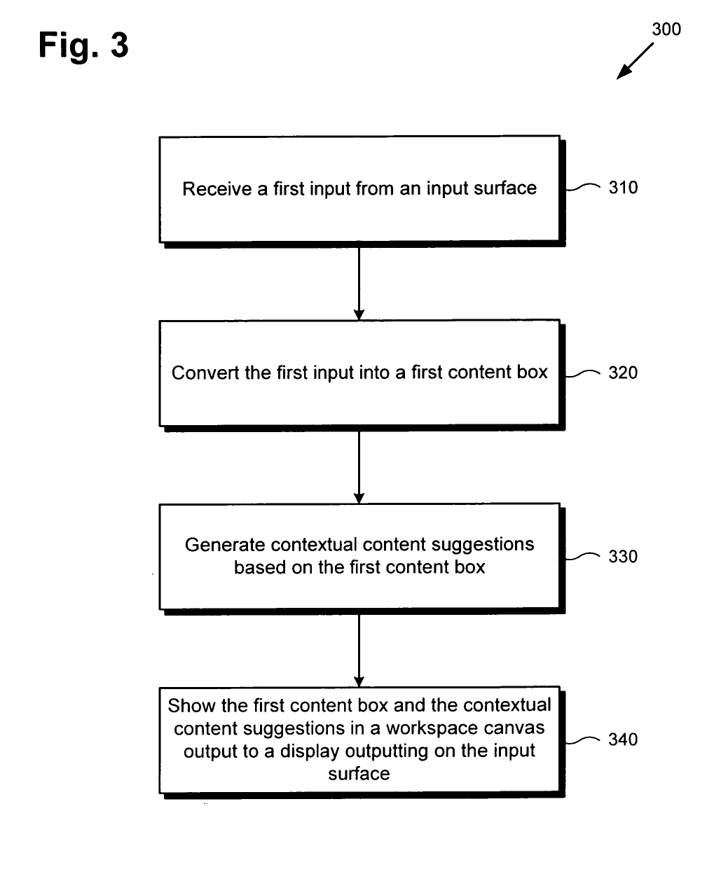

Moving to FIG. 3, FIG. 3 shows a flowchart describing the steps, according to one embodiment of the present invention, by which the Figment collaboration system may be provided. Certain details and features have been left out of flowchart 300 that are apparent to a person of ordinary skill in the art. For example, a step may comprise one or more substeps or may involve specialized equipment or materials, as known in the art. While steps 310 through 340 indicated in flowchart 300 are sufficient to describe one embodiment of the present invention, other embodiments of the invention may utilize steps different from those shown in flowchart 300.

Referring to step 310 of flowchart 300 in FIG. 3 and diagram 100 of FIG. 1, step 310 of flowchart 300 comprises processor 111 of server 110 receiving a first input from dual digitizer surface 130. Thus, user 160 may use digitizer marker 135 or touch gestures to begin writing on dual digitizer surface 130, which is then read as the first input by collaboration application 115 executing within memory 112 on processor 111 of server 110. Since collaboration application 115 may continuously output the state of a workspace canvas through display 120 onto dual digitizer surface 130, from the view of user 160 the visual feedback from dual digitizer surface 130 may appear similar to drawing directly on a traditional whiteboard. Thus, referring to diagram 200 of FIG. 2, after step 310, dual digitizer surface 130 may appear similar to dual digitizer surface 230d, where the first input may comprise the handwriting of “Space Mountain” in the empty area of the workspace canvas.

Referring to step 320 of flowchart 300 in FIG. 3 and diagram 100 of FIG. 1, step 320 of flowchart 300 comprises processor 111 of server 110 converting the first input from step 310 into a first content box. Step 320 may occur in response to receiving a second input, for example drawing a shape such as a rectangular shape around the first input. Thus, referring to diagram 200 of FIG. 2, after step 320, dual digitizer surface 130 may appear similar to dual digitizer surface 230e, where user 160 may have drawn a rectangular box around the handwritten “Space Mountain”, which causes an automatic conversion into the first content box. As shown in dual digitizer surface 230e, the handwriting has been converted within the first content box into the machine-readable text “Space Mountain”. Alternatively, as previously discussed, step 320 may occur in response to manual activation by for example pressing a text conversion button, which might be placed in a corner of the content box. Such a manual activation process may for example occur in the transition between dual digitizer surface 230b and dual digitizer surface 230c.

Referring to step 330 of flowchart 300 in FIG. 3 and diagram 100 of FIG. 1, step 330 of flowchart 300 comprises processor 111 of server 110 generating contextual content suggestions based on the first content box provided after step 320. Thus, referring to diagram 200 of FIG. 2, after step 330, dual digitizer surface 130 may appear similar to dual digitizer surface 230f, where images 231a through 231c are presented as contextual content suggestions. As previously discussed, the contextual content suggestions may use any number of factors, such as the state of the workspace canvas, including the presence and proximity of the “Magic Kingdom” and “Space Mountain” content boxes, user profile data, or past history data. Data for the contextual content suggestions may be retrieved from a wide variety of sources, including any sources accessible through network and/or other communication protocol 140 such as web content, database content, or data from clients 170a and 170b. As shown in dual digitizer surface 230f, the contextual content suggestions may comprise a plurality of content boxes.

Referring to step 340 of flowchart 300 in FIG. 3 and diagram 100 of FIG. 1, step 340 of flowchart 300 comprises processor 111 of server 110 showing the first content box from step 320 and the contextual content suggestions from step 330 in the workspace canvas output to projector 120 outputting to dual digitizer surface 130. Thus, referring to diagram 200 of FIG. 2, after step 330, dual digitizer surface 130 may appear similar to dual digitizer surface 230f, where both the “Space Mountain” content box and the contextual content suggestions of images 231a through 231c are visible. After step 340, user 160 may, for example, select only image 231b from the generated contextual content suggestions, causing the remaining suggestions to disappear from the workspace canvas as shown in dual digitizer surface 230g. Additionally, as previously discussed, user 160 is free to optimize the organization of the workspace canvas by moving, rearranging, and creating relationships between content boxes. User 160 may also initiate various advanced collaboration commands by generating and using buttons such as button 232.

Furthermore, collaboration application 115 may accept content boxes from other collaborators, such as the users of client 170a and 170b, or from other users in remote locations accessible through network and/or other communication protocol 140. Designated moderators such as user 160 may then solicit feedback from participating collaborators and decide whether to integrate or discard user generated content. Submitted content boxes may not be limited to merely static text and images but may also include database entries, video clips, web links or other Internet content, widgets such as social networking applications, chat or conferencing windows with other users, and other types of content, which may be accessed through network and/or other communication protocol 140.

In this manner, rich dynamic content for high impact presentations and enhanced collaboration may be supported, providing advanced functionality not possible with conventional tools such as whiteboards. At the same time, due to the intelligence of the collaboration system providing the most contextually relevant content and the adaptation to specific user profiles, behaviors and skill levels, users can comfortably operate the Figment collaboration system while avoiding the usual stress and frustration of conventional collaboration user interfaces.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for providing an intuitive collaborative user interface, the method comprising:
receiving a first input from an input surface;
converting the first input into a first content box;
generating contextual content suggestions based on the first content box; and
showing the first content box and the contextual content suggestions in a workspace canvas output to a display outputting on the input surface.

2. The method of claim 1, wherein the input surface comprises a digitizer and a touch sensitive surface.

3. The method of claim 1, wherein the display comprises one of a short throw projector and an LCD display panel.

4. The method of claim 1 further comprising prior to converting the first input receiving a second input from the input surface, and wherein the converting of the first input is in response to receiving the second input comprising drawing a shape around the first input.

5. The method of claim 1 further comprising prior to converting the first input receiving a second input from the input surface, and wherein the converting of the first input is in response to receiving the second input comprising drawing a rectangular shape around the first input.

6. The method of claim 1, wherein the converting of the first input is by using optical character recognition (OCR) to create a text string using a machine-readable text encoding within the first content box.

7. The method of claim 1, wherein the generating of the contextual content suggestions is based on a state of the workspace canvas.

8. The method of claim 1 further comprising prior to receiving the first input identifying a user providing the first input, and wherein the generating of the contextual content suggestions is based on a profile of the user.

9. The method of claim 1, wherein the contextual content suggestions comprise a plurality of content boxes populated with data retrieved from a network.

10. The method of claim 1 further comprising:
receiving, through a network, a second content box from a client; and
showing the second content box in the workspace canvas outputting to the display.

11. A system for providing an intuitive collaborative user interface, the system comprising:
an input surface;
a display outputting on the input surface; and
a server having a processor configured to:
receive a first input from the input surface;
convert the first input into a first content box;
generate contextual content suggestions based on the first content box; and
show the first content box and the contextual content suggestions in a workspace canvas output to the display.

12. The system of claim 11, wherein the input surface comprises a digitizer and a touch sensitive surface.

13. The system of claim 11, wherein the display comprises one of a short throw projector and an LCD display panel.

14. The system of claim 11, wherein prior to converting the first input the processor is configured to receive a second input from the input surface, and wherein the processor is further configured to convert the first input in response to receiving the second input comprising drawing a shape around the first input.

15. The system of claim 11, wherein prior to converting the first input the processor is configured to receive a second input from the input surface, and wherein the processor is further configured to convert the first input in response to receiving the second input comprising drawing a rectangular shape around the first input.

16. The system of claim 11, wherein the processor is further configured to convert the first input by using optical character recognition (OCR) to create a text string using a machine-readable text encoding within the first content box.

17. The system of claim 11, wherein the processor is further configured to generate the contextual content suggestions based on a state of the workspace canvas.

18. The system of claim 11, wherein prior to receiving the first input the processor is configured to identify a user providing the first input, and wherein the processor is further configured to generate the contextual content suggestions based on a profile of the user.

19. The system of claim 11, wherein the contextual content suggestions comprise a plurality of content boxes populated with data retrieved from a network.

20. The system of claim 11, wherein the processor is further configured to:
receive, through a network, a second content box from a client; and
show the second content box in the workspace canvas outputting to the display.
